(19) United States
(12) Patent Application Publication
(10) Pub. No.: US 2016/0291975 A1
(43) Pub. Date: Oct. 6, 2016

(54) METHOD OF COMPILING PROGRAM, STORAGE MEDIUM, AND APPARATUS

(71) Applicant: FUJITSU LIMITED, Kawasaki-shi (JP)

(72) Inventors: Takushi HASHIDA, Munich (DE); Minoru Nakamura, Kawasaki (JP); Motoyuki Kawaba, Kawasaki (JP)

(73) Assignee: FUJITSU LIMITED, Kawasaki-shi (JP)

(21) Appl. No.: 15/010,089

(22) Filed: Jan. 29, 2016

(30) Foreign Application Priority Data
Mar. 30, 2015 (JP) 2015-069601

(51) Int. Cl. G06F 9/30

(52) U.S. Cl. CPC G06F 9/30032

(57) ABSTRACT

A method of compiling a program that executes a plurality of unit processes in parallel, the method includes: replacing a load instruction of a volatile variable, the volatile variable being a variable included in the program and having a possibility of being overwritten by another unit process, with a beginning load instruction indicating a beginning of a range of transactionization and a load, and an end instruction indicating an ending of the range of the transactionization; moving the beginning load instruction before a position of the load instruction of the volatile variable in the program by instruction scheduling; and generating a beginning instruction indicating a beginning of a range of the transactionization and a load instruction of the volatile variable from the moved beginning load instruction.

### CROSS-REFERENCE TO RELATED APPLICATION

This application is based upon and claims the benefit of priority of the prior Japanese Patent Application No. 2015-069601, filed on Mar. 30, 2015, the entire contents of which are incorporated herein by reference.

### FIELD

The embodiments discussed herein are related to a method of compiling a program, a storage medium, and an apparatus.

### BACKGROUND

When a computer executes a program, since memory access speed is slower than the processing speed of a central processing unit (CPU), it is a convention to execute a load instruction from memory as early as possible. Accordingly, a compiler moves a load instruction forward in an instruction sequence by instruction scheduling such that the load instruction is executed as early as possible.

Also, a compiler embeds a prefetch instruction that reads data predicted to be used in the future into a cache memory in advance so as to increase the memory access speed.

In this regard, a related-art technique is known in which execution of a multithreaded application is divided into two or more quanta specifying an operation of a deterministic number, and a thread specifies the deterministic order of executing the two or more quanta.

As an example of a related art, Japanese National Publication of International Patent Application No. 2011-507112 is known.

### SUMMARY

According to an aspect of the invention, a method of compiling a program that executes a plurality of unit processes in parallel, the method includes: replacing a load instruction of a volatile variable, the volatile variable being a variable included in the program and having a possibility of being overwritten by another unit process, with a beginning load instruction indicating a beginning of a range of transactionization and a load, and an end instruction indicating an ending of the range of the transactionization; moving the beginning load instruction before a position of the load instruction of the volatile variable in the program by instruction scheduling; and generating a beginning instruction indicating a beginning of a range of the transactionization and a load instruction of the volatile variable from the moved beginning load instruction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is an explanatory diagram of a lock method;

FIG. 1B is an explanatory diagram of an HTM;

FIG. 2 is an explanatory diagram of code generated by a compiling apparatus according to an embodiment;

FIG. 3 illustrates a functional configuration of the compiling apparatus according to the embodiment;

FIG. 4 is a flowchart illustrating a processing flow by a transactionization unit;

FIG. 5 is a flowchart illustrating a processing flow by a scheduling unit;

FIG. 6 is an explanatory diagram of a preceding merge basic block;

FIG. 7 is a flowchart illustrating a schedule processing flow in a block;

FIG. 8 is a flowchart illustrating a processing flow by a generation unit;

FIG. 9 illustrates a hardware configuration of a computer that executes a compile program according to the embodiment; and

FIG. 10 is an explanatory diagram of instruction scheduling in the related art.

### DESCRIPTION OF EMBODIMENTS

In the related art, instruction scheduling, in which a load instruction is moved forward in an instruction sequence as much as possible, has a problem in that it is difficult to move the load instruction of a volatile variable out of a basic block.

A volatile variable is a variable that might be overwritten by other threads in a multithreaded program. Also, a basic block is a block of an instruction sequence having one entry and one exit and is a block that does not internally include a branch. Also, a thread is a unit of use by a CPU, and one program is sometimes executed as a plurality of threads in parallel. Following, a description will be given of instruction scheduling in the related art.

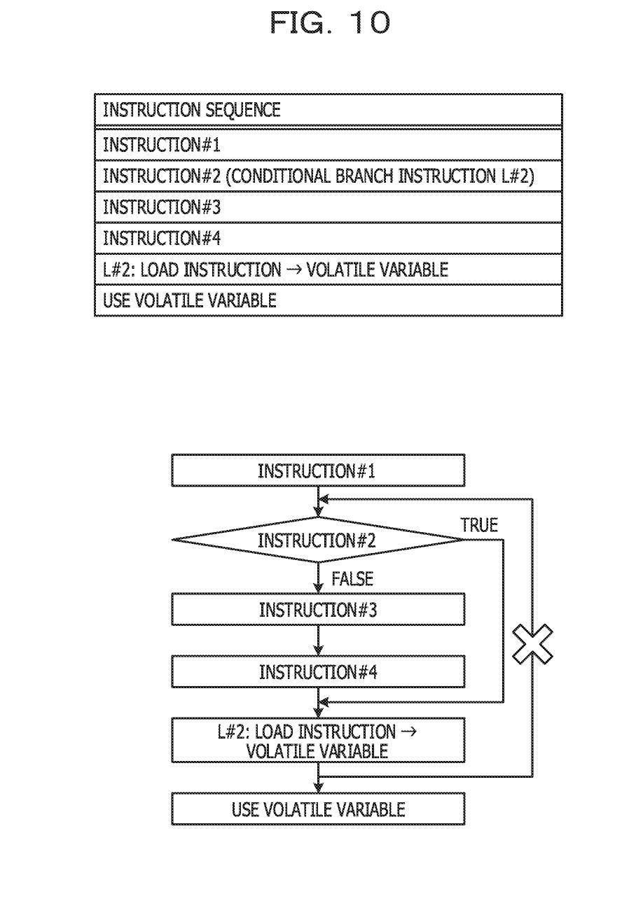

FIG. 10 is an explanatory diagram of instruction scheduling in the related art. As illustrated in FIG. 10, it is assumed that instructions are arranged in the order of “instruction#1”, “instruction#2 (conditional branch instruction L#2)”, “instruction#3”, “instruction#4”, “L#2: load instruction->volatile variable”, and “USE volatile variable”.

Here, “L#2” is a label, and “conditional branch instruction L#2” represents a branch to “L#2” if the condition is met. Also, “load instruction->volatile variable” represents a load instruction of a volatile variable, and “USE volatile variable” represents that the loaded volatile variable is used.

In FIG. 10, “instruction#3” and “instruction#4” constitute one basic block, and “load instruction->volatile variable” and “USE volatile variable” constitute another basic block. Accordingly, in the instruction scheduling in the related art, it is not possible to move “load instruction->volatile variable”. Also, in the instruction scheduling in the related art, it is difficult for an instruction to be moved ahead of a memory instruction. The memory instruction is an access instruction to memory.

According to an embodiment, it is desirable to move a load instruction of a volatile variable out of a basic block in the instruction scheduling.

Following, a detailed description will be given of an embodiment of the present disclosure with reference to the drawings. In this regard, the embodiment does not limit the disclosed technique.

### Embodiment

First, a description will be given of a CPU that executes code generated by a compiling apparatus according to the embodiment. The CPU that executes code generated by the compiling apparatus according to the embodiment includes a hardware transactional memory (HTM). The HTM is a mechanism for supporting exclusive control. An exclusive control method includes a lock method, but the HTM achieves higher parallelism than the lock method by speculative execution of instructions.

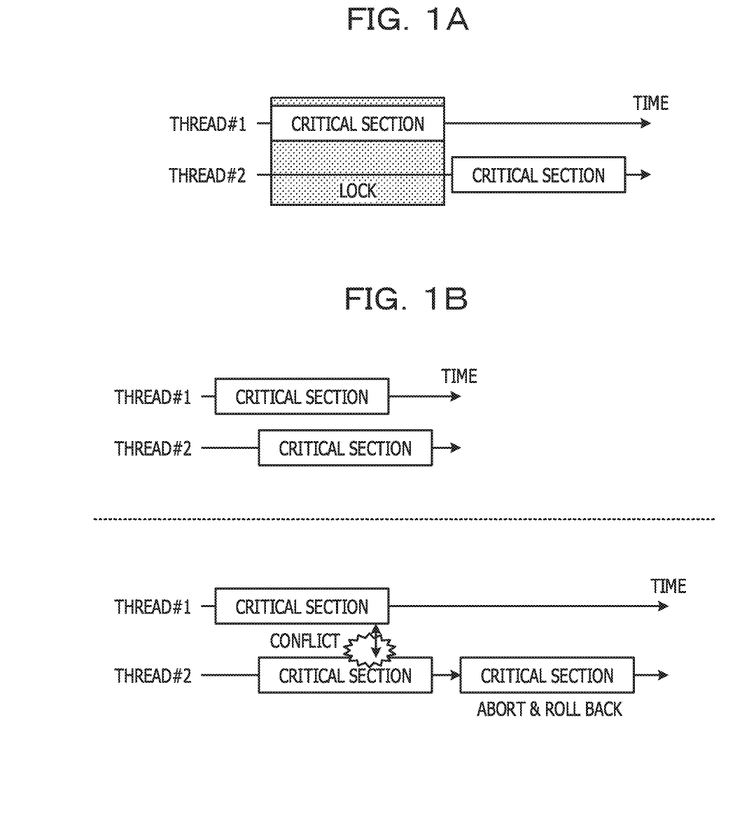

FIG. 1A is an explanatory diagram of a lock method. FIG. 1B is an explanatory diagram of the HTM. In FIGS. 1A and 1B, “thread#1” and “thread#2” are threads, “critical section” is a resource (memory location, or the like) in which the exclusive control is performed. Also, “time” represents time.

As illustrated in FIG. 1A, in the lock method, while thread#1 is executing processing in a critical section, the critical section is locked, and thus it is not possible for thread#2 to execute processing in the critical section. Then, thread#2 is allowed to execute processing in the critical section after thread#1 has completed processing in the critical section.

On the other hand, as illustrated in FIG. 1B, the HTM enables thread#1 and thread#2 to execute processing in parallel in the critical section, thereby achieving high performance. However, if a conflict occurs in the critical section due to the parallel execution, the HTM reperforms the processing (abort & roll back) in order to keep the processing consistent.

The compiling apparatus according to the embodiment generates code that uses the HTM so as to make it possible to load a volatile variable in advance. For example, the compiling apparatus according to the embodiment transactionizes a load instruction of a volatile variable. The transactionized load instruction is re-executed if a conflict occurs at execution time.

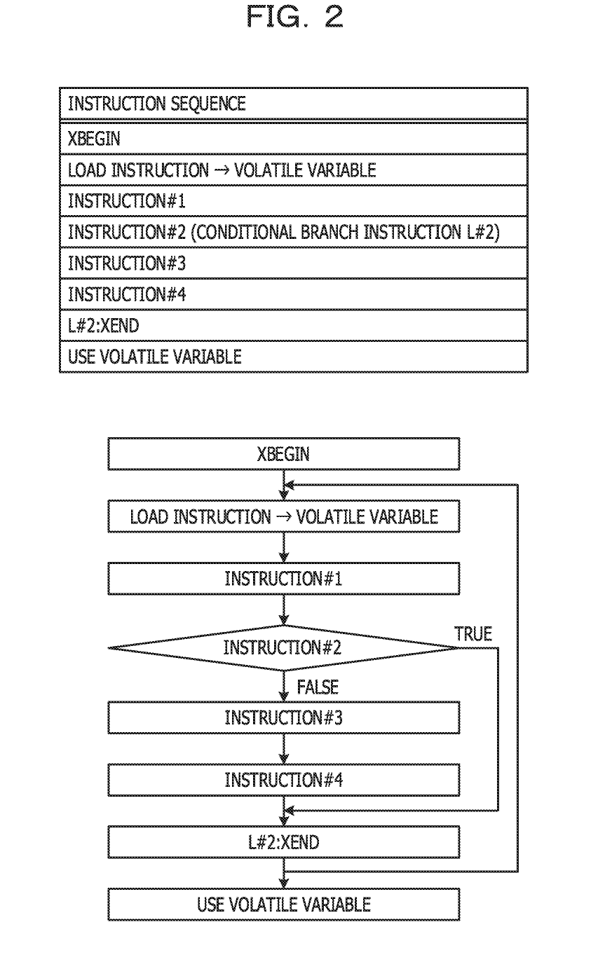

FIG. 2 is an explanatory diagram of code generated by the compiling apparatus according to the embodiment. In FIG. 2, the HTM performs exclusive control of a volatile variable in a range between an XBEGIN instruction and an XEND instruction. Accordingly, the compiling apparatus according to the embodiment generates code that contains the volatile variable load instruction between the XBEGIN instruction and the XEND instruction so as to make it possible to move the volatile variable load instruction forward out of the basic block. In FIG. 2, “load instruction->volatile variable” located after “instruction#4” in FIG. 10 is moved to before “instruction#1”.

In this manner, the compiling apparatus according to the embodiment generates code that uses the HTM to enable a volatile variable to be loaded in advance to achieve high-speed execution of a multithreaded program.

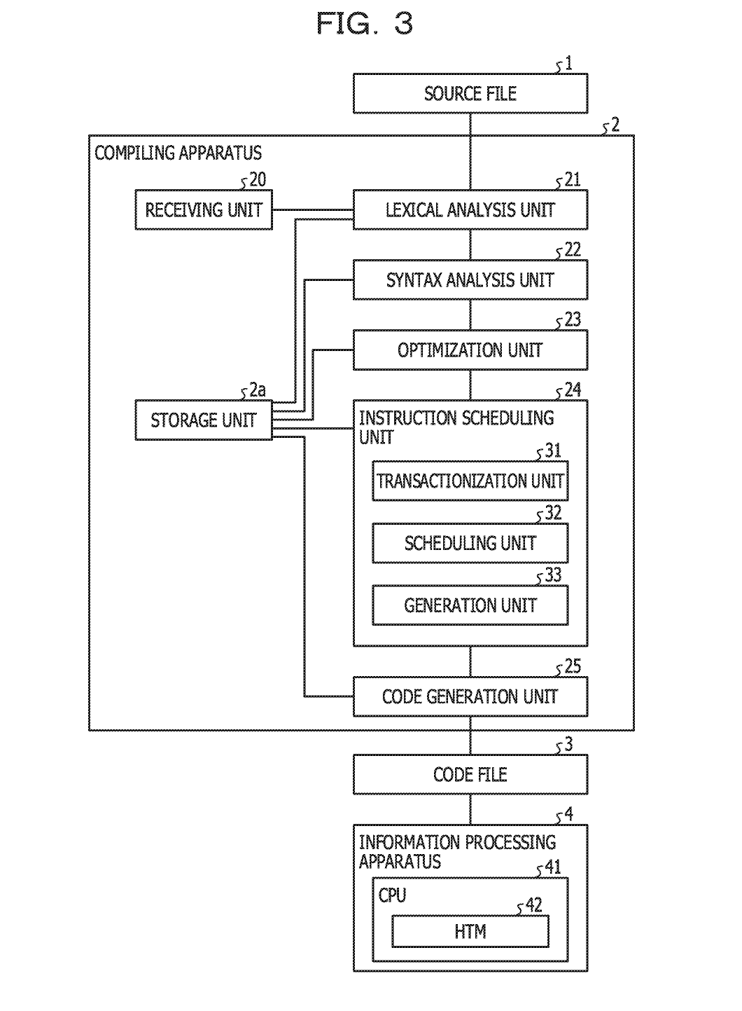

Next, a description will be given of a functional configuration of the compiling apparatus according to the embodiment. FIG. 3 illustrates the functional configuration of the compiling apparatus according to the embodiment. As illustrated in FIG. 3, a compiling apparatus 2 according to the embodiment includes a storage unit 2a, a receiving unit 20, a lexical analysis unit 21, a syntax analysis unit 22, an optimization unit 23, an instruction scheduling unit 24, and a code generation unit 25.

The storage unit 2a stores compiling operation intermediate information, such as a lexical analysis result, a syntax analysis result, an optimization result, an instruction scheduling result, and the like. Also, the storage unit 2a stores information for use in compile processing, such as a lexical analysis, syntax rules, and the like.

The receiving unit 20 receives a compile instruction from a user using an input device, such as a keyboard, a mouse, or the like. The lexical analysis unit 21 reads source code for a program from a source file 1, performs lexical analysis, and writes the lexical analysis result to the storage unit 2a.

The syntax analysis unit 22 performs syntax analysis of the source program based on the lexical analysis result and writes the syntax analysis result to the storage unit 2a. The optimization unit 23 performs optimization on the syntax analysis result, such as loop optimization, and the like in order to increase the speed of the program. The optimization unit 23 writes the optimized instruction sequence to the storage unit 2a.

The instruction scheduling unit 24 performs instruction scheduling on the optimization result. That is to say, the instruction scheduling unit 24 moves a load instruction to the front part of the instruction sequence such that the load instruction is executed precedingly in the instruction sequence, and writes the moved result to the storage unit 2a. The instruction scheduling unit 24 includes a transactionization unit 31, a scheduling unit 32, and a generation unit 33.

The transactionization unit 31 transactionizes a load instruction of a volatile variable. For example, the transactionization unit 31 replaces a load instruction of a volatile variable with an (XBEGIN+normal load) instruction and the XEND instruction. Here, the (XBEGIN+normal load) instruction is an instruction including the XBEGIN instruction and “load instruction->volatile variable”.

The scheduling unit 32 moves the (XBEGIN+normal load) instruction to the front part of the instruction sequence such that a certain number of instructions are executed between the (XBEGIN+normal load) instruction and the XEND instruction. Here, the certain number is determined based on the amount of delay in variable access. The (XBEGIN+normal load) instruction is subjected to instruction scheduling in the same manner as the normal load instruction.

Also, the XEND instruction is not moved in the instruction sequence. However, the XEND instruction may be subjected to instruction scheduling under the same restrictions as the load instruction of a volatile variable. That is to say, the XEND instruction may be moved in the instruction sequence in the range not exceeding the basic block. Also, the XEND instruction may be moved in the instruction sequence in the range not including a change in the order with the other memory access instructions.

The generation unit 33 replaces the (XBEGIN+normal load) instruction that has been moved by the scheduling unit 32 with the XBEGIN instruction and the normal load instruction.

In this manner, the instruction scheduling unit 24 moves the (XBEGIN+normal load) instruction by instruction scheduling in the same manner as a normal load instruction and replaces the (XBEGIN+normal load) instruction with the XBEGIN instruction and the normal load instruction after the move. Accordingly, it is possible for the instruction scheduling unit 24 to generate code in which a load instruction of a volatile variable is executed in advance, and exclusive control by the HTM is applied to the volatile variable.

The code generation unit 25 generates an instruction code based on the result of moving the load instruction and outputs the instruction code as a code file 3. The instruction code of the code file 3 is changed to a machine language sequence by an assembler and is then executed by the information processing apparatus 4 including an HTM 42 in a CPU 41.

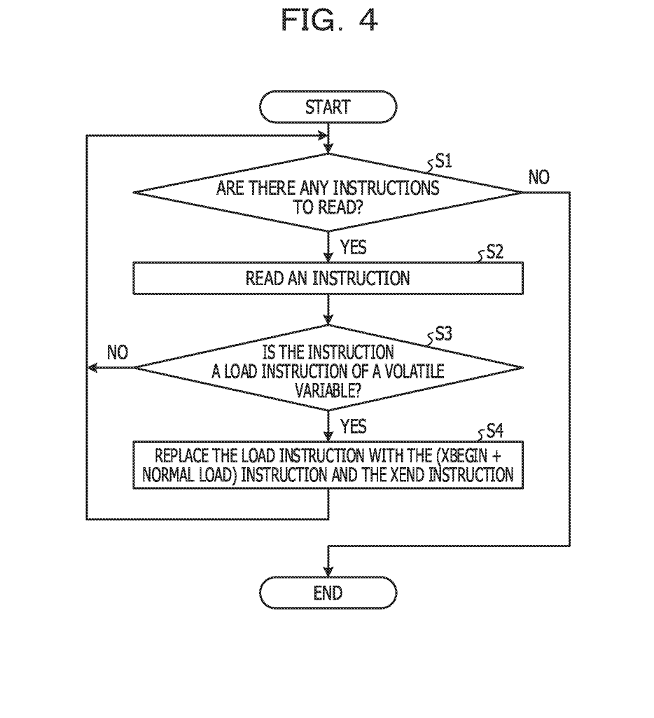

Next, a description will be given of a flow of each processing unit of the instruction scheduling unit 24 using FIG. 4 to FIG. 8. FIG. 4 is a flowchart illustrating a processing flow by a transactionization unit 31. In this regard, the storage unit 2a stores an instruction sequence optimized by the optimization unit 23.

As illustrated in FIG. 4, the transactionization unit 31 determines whether or not there is an instruction to be read in the storage unit 2a (step S1). As a result, if there are no instructions to be read, the transactionization unit 31 terminates the processing.

On the other hand, if there is an instruction, the transactionization unit 31 reads the instruction (step S2) and determines whether or not the read instruction is a volatile variable load (step S3). As a result of the determination, if the read instruction is not a volatile variable load, the transactionization unit 31 returns the processing to step S1.

On the other hand, if the read instruction is a volatile variable load, the transactionization unit 31 replaces the load instruction with the (XBEGIN+normal load) instruction and the XEND instruction (step S4) and returns the processing to step S1.

In this manner, the transactionization unit 31 replaces a load instruction of a volatile variable with the (XBEGIN+normal load) instruction and the XEND instruction so that it is possible for the compiling apparatus 2 to generate code using the HTM.

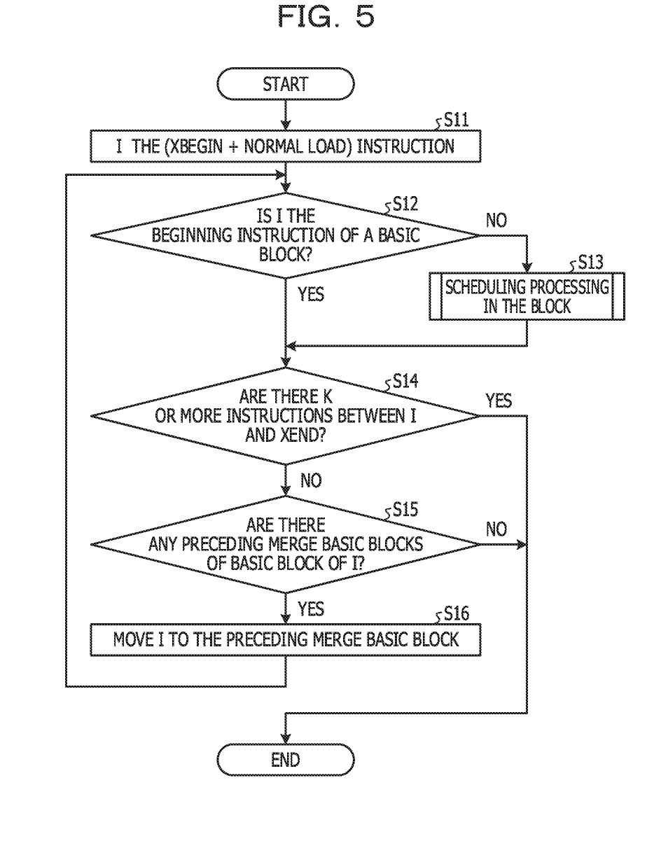

FIG. 5 is a flowchart illustrating a processing flow by the scheduling unit 32. As illustrated in FIG. 5, the scheduling unit 32 sets the (XBEGIN+normal load) instruction to I (step S11).

The scheduling unit 32 then determines whether or not I is the beginning instruction in the basic block (step S12), and if I is not the beginning instruction, the scheduling unit 32 performs in-block schedule processing for moving I to the beginning of the basic block (step S13).

The scheduling unit 32 then determines whether or not there are K or more instructions between I and the XEND instruction (step S14). K is the number of instructions to be executed between the (XBEGIN+normal load) instruction and XEND. If there are K or more instructions between I and the XEND instruction (step S14: Yes), the scheduling unit 32 terminates the processing.

On the other hand, if there are not K or more instructions between I and the XEND instruction (step S14: No), the scheduling unit 32 determines whether there is a preceding merge basic block to a basic block of I (step S15). As a result of the determination, if there is no preceding merge basic block (step S15: No), the scheduling unit 32 terminates the processing. On the other hand, if there is a preceding merge basic block (step S15), the scheduling unit 32 moves I to the preceding merge basic block (step S16) and returns to step S12.

Here, if the following conditions exist between the two basic blocks B#x and B#y, B#x is called as a preceding merge basic block of B#y. The conditions are “after B#x is executed, any basic blocks other than B#x and B#y are executed any number of times by passing through any paths, and B#y is executed” and “before B#y is executed, B#x is executed without fail”.

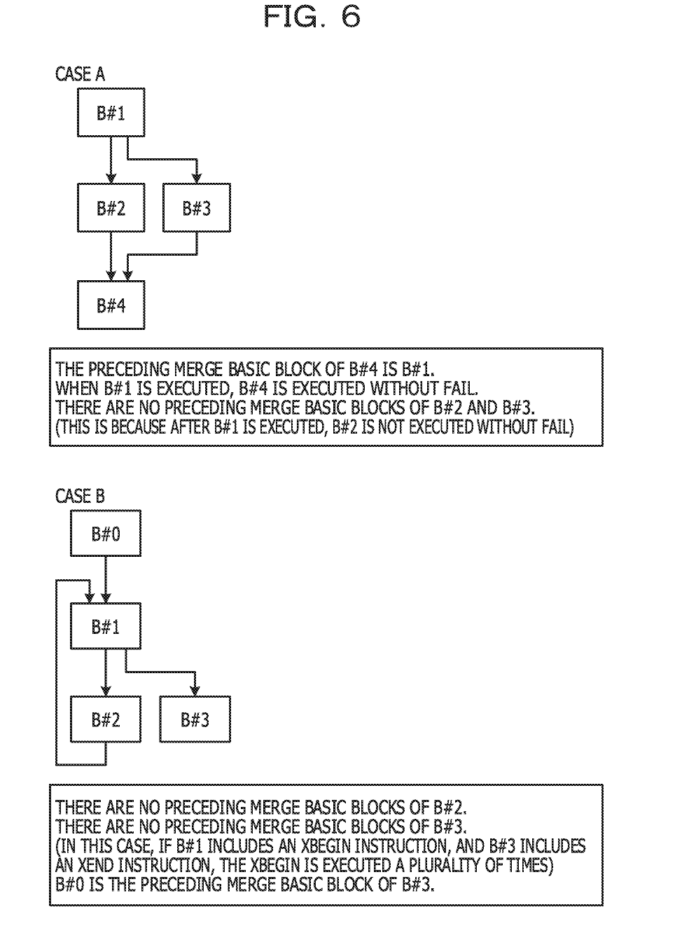

FIG. 6 is an explanatory diagram of a preceding merge basic block. In FIG. 6, B#0 to B#4 are basic blocks. In case A in FIG. 6, a preceding merge basic block of B#4 is B#1. When B#1 is executed, B#4 is executed without fail. On the other hand, in case A, there are no preceding merge basic blocks of B#2 and B#3. After B#1 is executed, B#2 does not have to be executed. In this manner, there are no preceding merge basic blocks in some cases.

In case B in FIG. 6, there are no preceding merge basic blocks of B#2. Also, there are no preceding merge basic blocks of B#3. If B#1 includes an XBEGIN instruction and B#3 includes an XEND instruction, in case B, the XBEGIN instruction is executed a plurality of times. Also, B#0 is a preceding merge basic block of B#3.

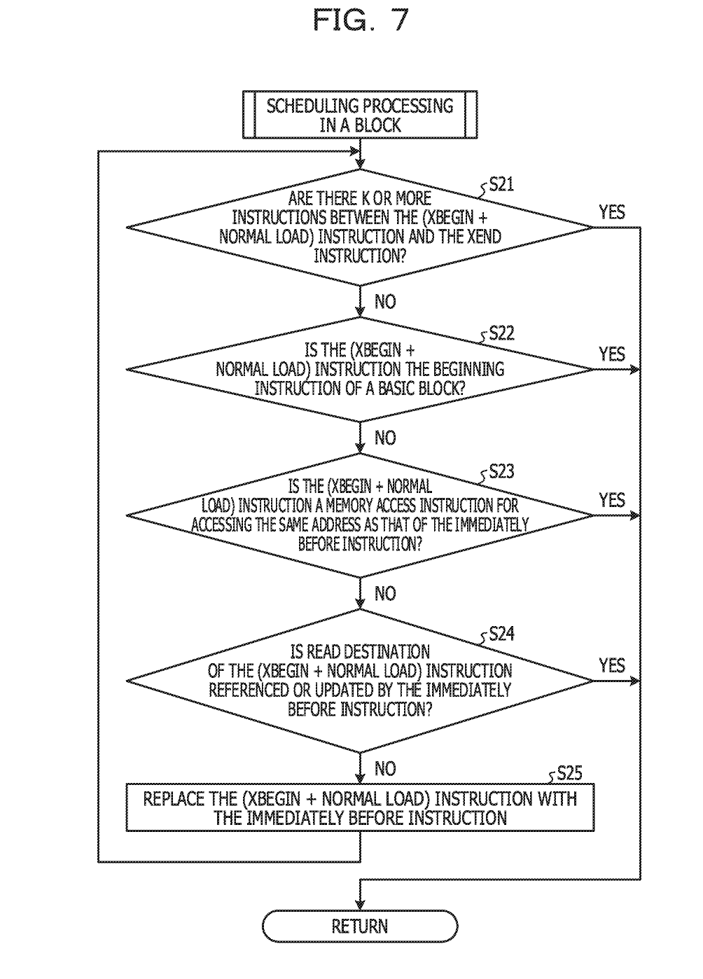

FIG. 7 is a flowchart illustrating a schedule processing flow in a block. As illustrated in FIG. 7, the scheduling unit 32 determines whether or not there are K or more instructions between the (XBEGIN+normal load) instruction and the XEND instruction (step S21). If there are K or more instructions (step S21: Yes), the scheduling unit 32 terminates the processing.

On the other hand, if there are not K or more instructions (step S21: No), the scheduling unit 32 determines whether or not the (XBEGIN+normal load) instruction is the beginning instruction of the basic block (step S22). If the (XBEGIN+normal load) instruction is the beginning instruction of the basic block (step S22: Yes), the scheduling unit 32 terminates the processing.

On the other hand, if the (XBEGIN+normal load) instruction is not the beginning instruction of the basic block (step S22: No), the scheduling unit 32 determines whether the (XBEGIN+normal load) instruction is a memory access instruction for accessing the same address as the immediately before instruction (step S23). If the (XBEGIN+normal load) instruction is a memory access instruction for accessing the same address as that of the immediately before instruction (step S23: Yes), the scheduling unit 32 terminates the processing.

On the other hand, if the (XBEGIN+normal load) instruction is not a memory access instruction for accessing the same address as that of the immediately before instruction (step S23: No), the scheduling unit 32 determines whether the read destination of the (XBEGIN+normal load) instruction has been referenced or updated by the immediately before instruction (step S24). As a result of the determination, if the read destination of the (XBEGIN+normal load) instruction has been referenced or updated by the immediately before instruction (step S24: Yes), the scheduling unit 32 terminates the processing.

On the other hand, if the read destination of the (XBEGIN+normal load) instruction has not been referenced or updated by the immediately before instruction (step S24: No), the scheduling unit 32 replaces the (XBEGIN+normal load) instruction with the immediately before instruction (step S25) and returns the processing to step S21.

In this manner, the scheduling unit 32 replaces the (XBEGIN+normal load) instruction with the immediately before instruction under certain restrictions so that it is possible for the scheduling unit 32 to move the (XBEGIN+normal load) instruction in the basic block as much as possible.

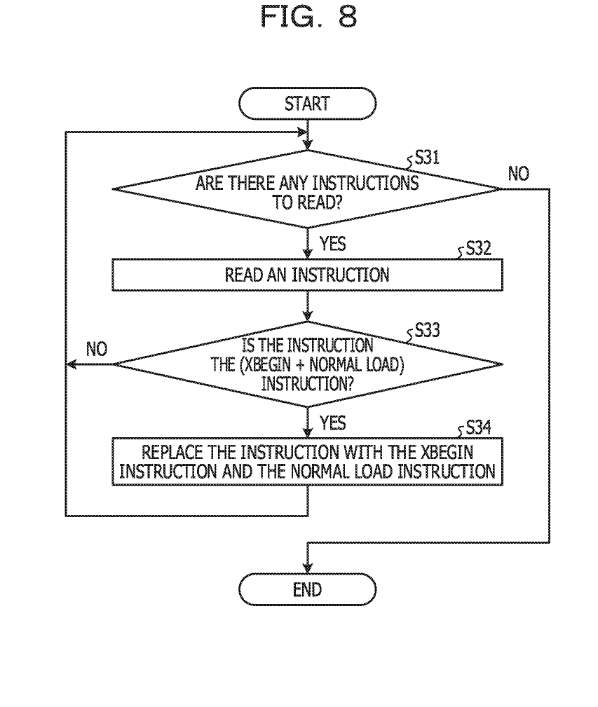

FIG. 8 is a flowchart illustrating a processing flow by the generation unit 33. As illustrated in FIG. 8, the generation unit 33 determines whether there are any instructions to be read in the storage unit 2a (step S31). As a determination result, if there are no instructions to be read (step S31: No), the generation unit 33 terminates the processing.

On the other hand, if there is an instruction to be read (step S31: Yes), the generation unit 33 reads the instruction (step S32) and determines whether the read instruction is the (XBEGIN+normal load) instruction or not (step S33). As a determination result, if the read instruction is not the (XBEGIN+normal load) instruction (step S33: No), the generation unit 33 returns the processing to step S31.

On the other hand, if the read instruction is the (XBEGIN+normal load) instruction (step S33: Yes), the generation unit 33 replaces the read instruction with the XBEGIN instruction and the normal load instruction (step S34) and returns the processing to step S31.

In this manner, the generation unit 33 replaces the (XBEGIN+normal load) instruction with the XBEGIN instruction and the normal load instruction so that it is possible for the compiling apparatus 2 to generate code using the HTM.

As described above, in the embodiment, the transactionization unit 31 replaces a load instruction of a volatile variable with the (XBEGIN+normal load) instruction and the XEND instruction, and the scheduling unit 32 moves the (XBEGIN+normal load) instruction to the front part of the instruction sequence. Then the generation unit 33 replaces the moved (XBEGIN+normal load) instruction with the XBEGIN instruction and the normal load instruction. Accordingly, it is possible for the compiling apparatus 2 to move the load instruction of a volatile variable out of the basic block in the same manner as the normal load instruction.

Also, in the embodiment, the scheduling unit 32 moves the (XBEGIN+normal load) instruction to the preceding merge basic block so that a corresponding relationship between the XBEGIN instruction and the XEND instruction is maintained.

Also, in the embodiment, the scheduling unit 32 moves the (XBEGIN+normal load) instruction to the beginning part in the basic block so that it is possible for the compiling apparatus 2 to generate code that executes the load instruction of the volatile variable in advance in the basic block.

Also, in the embodiment, the scheduling unit 32 moves the (XBEGIN+normal load) instruction such that a predetermined number of instructions are included between the (XBEGIN+normal load) instruction and XEND. Accordingly, it is possible for the compiling apparatus 2 to generate code that performs a preceding load based on the amount of delay in memory access.

In this regard, in the embodiment, a description has been given of the compiling apparatus 2. However, by achieving the functions of the compiling apparatus 2 with software, it is possible to obtain a compile program having the same functions. Thus, a description will be given of a computer that executes the compile program.

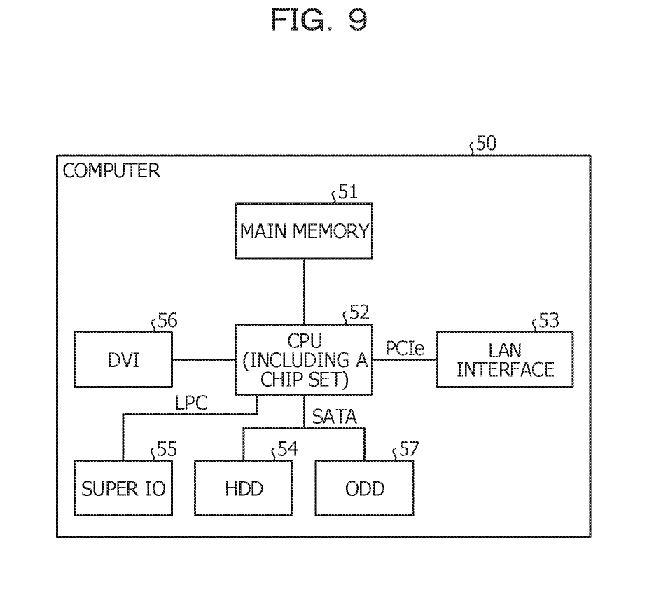

FIG. 9 illustrates a hardware configuration of a computer that executes a compile program according to the embodiment. As illustrated in FIG. 9, a computer 50 includes a main memory 51, a CPU 52, a local area network (LAN) interface 53, and a hard disk drive (HDD) 54. Also, the computer 50 includes a Super Input and Output (10) 55, a Digital Visual Interface (DVI) 56, and an optical disc drive (ODD) 57.

The main memory 51 is a memory for storing a program and an intermediate execution result of a program, or the like. The CPU 52 is a central processing unit that reads a program from the main memory 51 to execute the program. The CPU 52 includes a chip set including a memory controller.

The LAN interface 53 is an interface for coupling the computer 50 to the other computers via a LAN. The HDD 54 is a disk device that stores programs and data, the Super IO 55 is an interface for coupling an input device, such as a mouse, a keyboard, or the like. The DVI 56 is an interface for coupling a display device, and the ODD 57 is a device for reading from and writing to an optical disc, such as a digital versatile disc (DVD), or the like.

The LAN interface 53 is coupled to the CPU 52 by PCI Express (PCIe), and the HDD 54 and the ODD 57 are coupled to the CPU 52 by Serial Advanced Technology Attachment (SATA). The Super IO 55 is coupled to the CPU 52 by Low Pin Count (LPC).

The compile program to be executed on the computer 50 is stored on a DVD, is read from the DVD by the ODD 57 and is installed in the computer 50. Alternatively, the compile program is stored in a database of another computer system or the like that is coupled via the LAN interface 53, is read from the database and is installed on the computer 50. The installed compile program is then stored on the HDD 54 and is read into the main memory 51 to be executed by the CPU 52.

Also, in the embodiment, a description has been given of the case where the compiling apparatus 2 and the information processing apparatus 4 are separate devices. However, the present disclosure is not limited to this, and it is possible to apply the present disclosure to the case where the information processing apparatus 4 executes the compile program according to the embodiment in the same manner.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method of compiling a program that executes a plurality of unit processes in parallel, the method comprising:
replacing a load instruction of a volatile variable, the volatile variable being a variable included in the program and having a possibility of being overwritten by another unit process, with a beginning load instruction indicating a beginning of a range of transactionization and a load, and an end instruction indicating an ending of the range of the transactionization;
moving the beginning load instruction before a position of the load instruction of the volatile variable in the program by instruction scheduling; and
generating a beginning instruction indicating a beginning of a range of the transactionization and a load instruction of the volatile variable from the moved beginning load instruction.

2. The method according to claim 1, wherein
the moving moves the beginning load instruction to a preceding merge basic block.

3. The method according to claim 1, wherein
the moving moves the beginning load instruction to a beginning of a basic block.

4. The method according to claim 1, wherein
the moving moves the beginning load instruction such that a predetermined number of instructions are included between the beginning load instruction and the end instruction.

5. The method according to claim 1, wherein
the transactionization is executed by a hardware transactional memory.

6. A non-transitory storage medium storing a compiling program for causing a computer to execute a process compiling a program that executes a plurality of unit processes in parallel, the process comprising:
replacing a load instruction of a volatile variable, the volatile variable being a variable included in the program and having a possibility of being overwritten by another unit process, with a beginning load instruction indicating a beginning of a range of transactionization and a load, and an end instruction indicating an ending of the range of the transactionization;
moving the beginning load instruction before a position of the load instruction of the volatile variable in the program by instruction scheduling; and
generating a beginning instruction indicating a beginning of a range of the transactionization and a load instruction of the volatile variable from the moved beginning load instruction.

7. The non-transitory storage medium according to claim 6, wherein
the moving moves the beginning load instruction to a preceding merge basic block.

8. The non-transitory storage medium according to claim 6, wherein
the moving moves the beginning load instruction to a beginning of a basic block.

9. The non-transitory storage medium according to claim 1, wherein
the moving moves the beginning load instruction such that a predetermined number of instructions are included between the beginning load instruction and the end instruction.

10. The non-transitory storage medium according to claim 1, wherein
the transactionization is executed by a hardware transactional memory.

11. An apparatus comprising:
a memory configured to store a program that executes a plurality of unit processes in parallel as a target for compiling; and
a processor coupled to the memory and configured to:
replace a load instruction of a volatile variable, the volatile variable being a variable included in the program and having a possibility of being overwritten by another unit process, with a beginning load instruction indicating a beginning of a range of transactionization and a load, and an end instruction indicating an ending of the range of the transactionization;
move the beginning load instruction before a position of the load instruction of the volatile variable in the program by instruction scheduling; and
generate a beginning instruction indicating a beginning of a range of the transactionization and a load instruction of the volatile variable from the moved beginning load instruction.

12. The apparatus according to claim 11, wherein the processor is configured to move the beginning load instruction to a preceding merge basic block.

13. The apparatus according to claim 11, wherein the processor is configured to move the beginning load instruction to a beginning of a basic block.

14. The apparatus according to claim 11, wherein the processor is configured to move the beginning load instruction such that a predetermined number of instructions are included between the beginning load instruction and the end instruction.

15. The apparatus according to claim 11, wherein
the transactionization is executed by a hardware transactional memory.
